(19) United States
(12) Patent Application Publication
(10) Pub. No.: US 2014/0056682 A1
(43) Pub. Date: Feb. 27, 2014

(54) APPARATUS AND A METHOD FOR STACKING FLAT ARTICLES ON EDGE AND FOR LOADING THEM INTO A MULTI-COMPARTMENT TRAY, A POSTAL SORTING MACHINE AND A POSTAL SORTING METHOD

(71) Applicant: Solystic, Gentilly (FR)

(72) Inventor: Damien Hugues, Bourg Les Valence (FR)

(73) Assignee: SOLYSTIC, Gentilly Cedex (FR)

(21) Appl. No.: 13/994,039

(22) PCT Filed: Oct. 12, 2012
(86) PCT No.: PCT/FR2012/052334

§ 371 Date: Jun. 13, 2013

(30) Foreign Application Priority Data
Dec. 22, 2011 (FR) 1162315

(51) Int. Cl. B65G 57/00

(52) U.S. Cl. CPC B65G 57/00
USPC 414/788.9; 414/802

(57) ABSTRACT

Automatic stacking and loading apparatus having at least one tray-receiving surface for receiving a multi-compartment tray having a bottom plate provided with through windows, a stacker for stacking said flat articles in a stacking zone, moving fingers mounted to move between a low position in which they are set back from said tray-receiving surface and a high position in which they define a bearing surface for the flat articles while said flat articles are being stacked, said tray-receiving surface being mounted to move relative to said moving finger between a first position and a second position, in which positions said moving finger is successively in register with the window of said first compartment and then in register with the window of said second compartment. A sorting machine including such apparatus, and an automatic stacking and loading method implementing said apparatus.

### TECHNICAL FIELD

The invention relates generally to apparatus for automatically stacking flat articles on edge and for automatically loading them on edge into a multi-compartment tray having a bottom plate receiving the edges of the flat articles and provided with at least two through windows opening out into respective ones of first and second compartments of the multi-compartment tray, the automatic stacking and loading apparatus having at least one tray-receiving surface suitable for receiving at least one multi-compartment tray to be loaded, a stacking zone provided above the tray-receiving surface and suitable for receiving the flat articles while they are being stacked, and a stacker suitable for stacking the flat articles on edge in the stacking zone.

The invention relates also to a machine for sorting flat articles, the machine including at least one unstacker, conveyor means, sorting outlets into which the flat articles are to be distributed in compliance with a predetermined sorting plan, and apparatus for automatically stacking and loading flat articles on edge at the sorting outlets.

The invention relates also to a method of automatically stacking flat articles on edge and of automatically loading them on edge into a multi-compartment tray provided with a bottom plate receiving the edges of the flat articles and with an opening opposite from the bottom plate and allowing the flat articles to be loaded into the multi-compartment tray, the bottom plate being provided with first and second windows opening out into respective ones of first and second compartments.

The invention relates finally to a postal sorting method during which at least one of the following steps is performed: unloading flat articles stacked on edge from a multi-compartment tray; unstacking the flat articles, sorting the flat articles, stacking the flat articles, and loading the flat articles into a multi-compartment tray.

In the meaning of the invention, a “flat article” means, particularly but not exclusively, a mailpiece. Mailpieces that are suitable for being stacked and loaded using the apparatus of the invention may be of various sizes, and they may also have a variety of mechanical characteristics, in particular as regards stiffness. Such a mailpiece may, inter alia, be an ordinary letter, a magazine, an envelope with or without a window, a newspaper, or indeed a catalogue wrapped in plastic or in paper, with or without gussets.

### PRIOR ART

Stacking apparatus is in common use, in particular in the field of postal sorting. In known manner, such a type of stacking apparatus defines a stacking zone of variable dimensions and suitable for receiving the flat articles conveyed in a longitudinal direction and stacked against one another in a transverse direction. The downstream side of the stacking zone is defined by a jogging edge, against which the flat articles come into abutment. The first flat article in the stack comes to bear against a paddle that is movable transversely under the effect of the accumulation of the flat articles. That moving paddle is urged by a resilient element to exert a compression force on the stack, thereby making it possible to hold the flat articles in their on-edge position. The stacking apparatus includes a rotary actuator that is caused to move on arrival of each flat article going towards the stacking zone.

The Applicant has marketed stacker apparatus under the reference “Virgule Equipée” (Article No. 285590). In that stacker apparatus, the actuator comprises a hub from which a plurality of pairs of spurs extend. In addition, the spurs of the same pair are disposed symmetrically at 180° relative to each other. In service, the spurs periodically generate a longitudinal thrust force, either directly on the paddle as the first articles arrive, or on that stack that is being formed.

That known stacking apparatus is entirely suitable for processing letters, as confirmed by the commercial success it is enjoying. However, it does not make it possible for the flat articles stacked on edge in that way to be loaded automatically into a multi-compartment tray. In particular, such stacking and loading apparatus does not make it possible for flat articles to be loaded automatically on edge into a multi-compartment tray.

### SUMMARY OF THE INVENTION

An object of the invention is to remedy that drawback by proposing apparatus for automatically unloading flat articles on edge from a multi-compartment tray, a sorting machine including such apparatus, a method of automatically stacking flat articles on edge and of automatically loading them on edge into a multi-compartment tray, and a postal sorting method making it possible to automate the loading of flat articles on edge into multi-compartment trays so as to make these operations reliable and so as to improve the efficiency of processing of the flat articles while reducing the amount of handling of the flat articles.

To this end, the invention provides apparatus for automatically stacking flat articles on edge and for automatically loading them on edge into a multi-compartment tray having a bottom plate receiving the edges of the flat articles and provided with at least two through windows opening out into respective ones of first and second compartments of the multi-compartment tray, the automatic stacking and loading apparatus having at least one tray-receiving surface suitable for receiving at least one multi-compartment tray to be loaded, a stacking zone provided above the tray-receiving surface and suitable for receiving the flat articles while they are being stacked, and a stacker suitable for stacking the flat articles on edge in the stacking zone, said apparatus being characterized in that it has at least one moving finger designed to be in register with one of the windows in a multi-compartment tray placed on the tray-receiving surface, the moving finger being mounted to move relative to the tray-receiving surface and to the stacking zone between a low position in which its free end is set back from the tray-receiving surface and a high position in which its free end is flush with the stacking zone and defines a bearing surface for the flat articles that serves as a support for the flat articles while they are being stacked, the tray-receiving surface being mounted to move relative to the moving finger between a first position and a second position, in which positions the moving finger is designed to be successively in register with the window of the first compartment and then in register with the window of the second compartment.

The basic idea of the invention is to provide a moving finger that is suitable for passing through the multi-compartment tray so as to serve as a bearing surface for the flat articles before loading the compartments of the multi-compartment tray successively by moving the finger in translation. The flat articles can thus be stacked on edge automatically and loaded on edge automatically into a multi-compartment tray.

The automatic stacking and loading apparatus of the invention may advantageously have the following features:
the automatic stacking and loading apparatus may have at least one detector suitable for monitoring the stacking threshold for stacking of flat articles in the stacking zone and for controlling the movements of the moving finger and of the tray-receiving surface once a predetermined threshold value has been reached;
the automatic stacking and loading apparatus may have a row of moving fingers arranged to move simultaneously between the low and high positions;
the stacker is a rotary actuator of the bucket wheel type, and the automatic stacking and loading apparatus has at least one moving paddle provided facing the stacker and suitable for receiving in abutment the downstream face of the first flat article stacked in the stacking zone, and for moving away from the stacker as the flat articles are stacked behind the first flat article;
the automatic stacking and loading apparatus may have automatic supply means for automatically supplying said multi-compartment tray to said tray-receiving surface;
the automatic stacking and loading apparatus may have automatic removal means for automatically removing said multi-compartment tray from said tray-receiving surface;

The invention also provides a sorting machine for sorting flat articles, the machine including at least one unstacker, conveyor means, sorting outlets into which said flat articles are to be distributed in compliance with a predetermined sorting plan, and apparatus for stacking and loading flat articles on edge at said sorting outlets, said sorting machine being characterized in that it includes at least one automatic stacking and loading apparatus as described above.

The invention also provides a method of automatically stacking flat articles on edge and of automatically loading them on edge into a multi-compartment tray having a bottom plate receiving the edges of the flat articles and provided with at least two through windows opening out into respective ones of first and second compartments of the multi-compartment tray, said method being characterized in that it comprises at least:
a supply step during which at least one multi-compartment tray is placed on a tray-receiving surface so that a moving finger is in register with the window in the first compartment;
a first engagement step during which at least one moving finger is engaged into said multi-compartment tray through the window in said first compartment so that, above said tray-receiving surface, said finger defines a bearing surface suitable for receiving said flat articles stacked on edge;
a first stacking step during which the flat articles are stacked on edge on the bearing surface;
a first loading step during which the moving finger is retracted from the first compartment so that the edges of the flat articles are resting on the bottom plate;
a shift step during which the multi-compartment tray is moved so that the moving finger is in register with the window in the second compartment;
a second engagement step during which the same moving finger as the one used during the first engagement step is engaged through said window in the second compartment so that, above the tray-receiving surface, the free end of said finger defines the same bearing surface as during said first engagement step;
a second stacking step similar to the first stacking step;
a second loading step during which the moving finger is retracted from said second compartment so that the edges of said flat articles are resting on the bottom plate; and
a removal step during which the multi-compartment tray is removed from said tray-receiving surface.

During the automatic stacking and loading method, prior to implementing the stacking and loading method, at least one predetermined threshold value may be set as a function of the dimensions of the multi-compartment tray, and, during at least one of the first and second stacking steps, the level of stacking of flat articles is compared with the stacking threshold, and, when the level of stacking reaches the predetermined threshold value, the first loading step, the second loading step, and the shift step are caused to take place in succession.

The invention finally provides a postal sorting method during which at least one of the following steps is performed: unloading flat articles stacked on edge from a multi-compartment tray; unstacking the flat articles, sorting the flat articles, stacking the flat articles, and loading the flat articles into a multi-compartment tray, said postal sorting method being characterized in that the stacking and loading steps are performed as in the stacking and loading method described above.

### BRIEF DESCRIPTION OF THE DRAWINGS

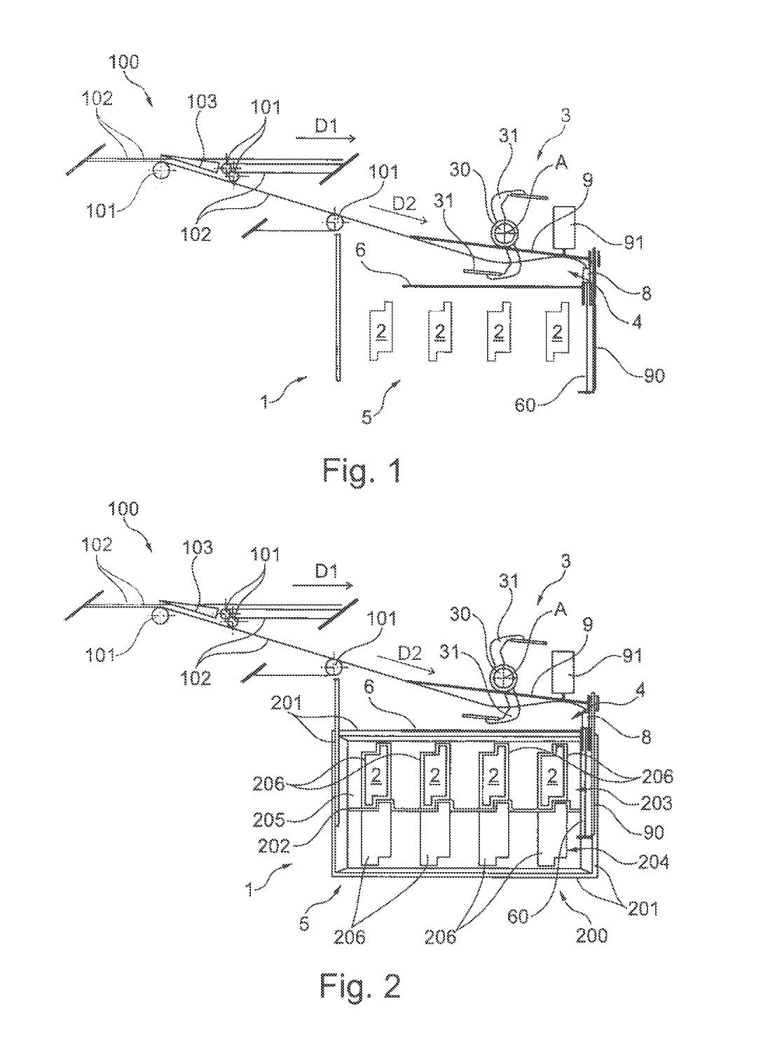

The present invention can be better understood and other advantages appear on reading the following detailed description of the embodiment given by way of non-limiting example and with reference to the accompanying drawings, in which FIGS. 1 to 6 are diagrammatic views of a portion of a flat article sorting machine including stacking apparatus of the invention shown in various different configurations of use for illustrating the automatic stacking and loading method of the invention.

### DESCRIPTION OF THE EMBODIMENTS

With reference to the figures, the apparatus of the invention for automatically stacking and loading flat articles 10 on edge is, for example, disposed at a sorting outlet of a sorting machine 100. In known manner, this sorting machine 100 has a stationary frame (not shown) carrying guide pulleys 101 for conveyor belts 102 for conveying the flat articles 10. These conveyor belts 102 thus define, for example, a main conveying direction indicated by arrow D1 and a secondary conveying direction indicated by arrow D2 and guiding the flat articles 10 towards the sorting outlet equipped with the automatic stacking and loading apparatus 1. The sorting machine 100 also has a switch flap 103 provided at the intersection between the main direction D1 and the secondary direction D2 and suitable for being pivoted automatically so as to direct the flat articles 10 towards the main direction D1 or the secondary direction D2 in compliance with a predetermined sorting plan.

The automatic stacking and loading apparatus 1 is designed to be used with multi-compartment trays 200 that are substantially mutually identical. Each of the multi-compartment trays 200 has a bottom plate 205, outer panels 201 and one or more partitions 202 defining at least a first compartment 203 and a second compartment 204, each of which is suitable for receiving flat articles 10 stacked on edge, their edges bearing against the bottom wall 205. Each first and second compartment 203, 204 is provided with a row of windows 206 passing through the bottom wall 205 and opening out respectively into the first compartment 203, and into the second compartment 204. These windows 206 are in the form of slots that are substantially mutually identical, that extend from an outer panel 201 facing the partition 202 to the partition 202, and that are in alignment so that their lengths are substantially perpendicular to the partition 202. Each of the windows 206 is substantially Z-shaped, comprising two branches separated by a stem. The windows 206 are suitable for allowing moving fingers 2 that are described below to pass through them.

The automatic stacking and loading apparatus 1 has a tray-receiving surface 5 suitable for receiving a multi-compartment tray 200, an actuator 3 suitable for stacking the flat articles 10, and a stacking zone 4 suitable for receiving the stacked flat articles 10 before they are loaded into the multi-compartment tray 200.

The actuator 3 is of the bucket wheel type and is mounted to rotate about an axis A that is substantially perpendicular to the main conveyor direction D1 and to the secondary conveyor direction D2. It is placed in the path of the flat articles 10 that, before stacking, follow the secondary direction D2. The actuator 3 comprises a hub 30 carried by a pin embodying the axis A and from which two spurs 31 extend that are curved in directions opposite to the direction in which the flat articles 10 arrive in the secondary conveying direction D2. The spurs 31 define slots suitable, depending on the rotation of the actuator 3, for finding themselves successively facing the arriving flat articles 10 so as to receive them successively and so as to accompany them while they are being stacked.

The stacking zone 4 is defined by the actuator 3, by a stationary jogging edge 8, by a moving paddle 6, and by a bearing surface. The jogging edge 8 is stationary relative to the frame, and tangential to the path of the spurs 31 of the actuator 3, which spurs are substantially perpendicular to the main direction D1 and to the secondary direction D2, and facing the arrival in the secondary direction D2 of the flat articles 10 to be stacked. The moving paddle 6 extends parallel to the main direction D1 and perpendicularly to the jogging edge 8. The moving paddle 6 is carried by a first guide rod 60 that is substantially perpendicular to the main direction D1, and relative to which it can move in translation between a start-of-stacking position (shown in FIGS. 1 and 2) in which it is close to the actuator 3 and an end-of-stacking position (shown in FIG. 4) in which it is remote from the actuator 3 from which it is separated by the flat articles 10 stacked between it and the actuator 3. This moving paddle 6 is also urged by return means (not shown) urging it to return to its start-of-stacking position. The stacking zone 4 is provided above the tray-receiving surface 5. Thus, as described in detail below, when a multi-compartment tray 200 is stood on the tray-receiving surface 5, the flat articles 10 are stacked above the first or second compartment 203, 204 into which they are to be placed, before they are loaded into the multi-compartment tray 200.

The flat articles 10 that follow the secondary direction D2 are thus stacked as they arrive, in the stacking zone 4. The stacking causes the moving paddle 6 to move gradually away from the axis A of the actuator 3. The automatic stacking and loading apparatus 1 further includes a presser flap 9 provided facing the moving paddle 6 and suitable for sliding relative to a second guide rod 90 that is substantially parallel to the first guide rod 60 to go between a retracted position in which it is set back relative to the path of the free ends of the spurs 31, and an advanced position in which it protrudes into the stacking zone 4 so that it can tamp the stack of flat articles 10 against the moving paddle 6. As shown in the figures, the presser flap 9 is, in addition, mounted to be pivotable to a small extent so that it can be better retracted when in its retracted position. The presser flap 9 is moved automatically, e.g. by means of an actuator 91.

The automatic stacking and loading apparatus 1 further includes a row of moving fingers 2 mounted to slide relative to the stacking zone 4 and relative to the tray-receiving surface 5, and suitable for sliding simultaneously between a low position in which they are set back from the tray-receiving surface 5 and a high position in which their free ends are above the tray-receiving surface 5 and come flush with the stacking zone 4 so as to define the bearing surface for the flat articles 10 stacked on edge in the stacking zone 4. The moving fingers 2 are mutually aligned substantially perpendicularly to the jogging edge 6. The moving fingers 2 are disposed so that, when a multi-compartment tray 200 is placed on the tray-receiving surface 5, each moving finger 2 is in register with a window 206. The moving fingers 2 are of shapes and sizes enabling them to pass through the windows 206. Thus, in their high position, the moving fingers 2 pass through the multi-compartment tray 200 to the extent of coming flush with the tops of outer panels 201, the bearing surface defined by their ends thus being mounted to move between the high position in which it serves as a support for the flat articles 10 being stacked and the low position in which the flat articles 10 have their edges bearing against the bottom plate 205, the bearing surface accompanying the flat articles 10 as they go down into the multi-compartment tray 200, and thereby enabling the multi-compartment tray 200 to be loaded automatically.

The tray-receiving surface 5 is mounted to move relative to the stacking surface 4 between first and second positions so as to move the multi-compartment tray 200 for the purpose of successively filling the first and second compartments 203, 204 of the multi-compartment tray 200. To this end, the tray-receiving surface 5 is coupled to any suitable means (not shown).

In a variant embodiment (not shown), the tray-receiving surface 5 is suitable for receiving a plurality of multi-compartment trays 200. In this variant embodiment, in addition to being moveable between the first and second positions, the tray-receiving surface is also mounted to move between the second position and a third position, and then a fourth position, the third and fourth positions serving to place the first and second compartments of the second multi-compartment tray in register with the stacking zone and to place the moving fingers in register successively with the windows of the first and second compartments of the second multi-compartment tray.

In another variant embodiment, each multi-compartment tray has a higher number of compartments, e.g. three. In which case, the tray-receiving surface is designed to be movable between first, second, and third positions.

The automatic stacking and loading apparatus 1 includes a control unit (not shown) suitable for controlling, in particular, the movement of the tray-receiving surface 5, of the moving paddle 6, of the moving fingers 2, and of the presser flap 9. The control unit is parameterized so as to control these movements as a function, in particular, of the presence of a multi-compartment tray 200 on the tray-receiving surface 5, and of a predetermined stacking threshold for the stack of flat articles 10 in the stacking zone 4. This threshold is modulated as a function, for example, of the dimensions of the multi-compartment tray 200 and of its first and second compartments 203, 204. To this end, the automatic stacking and loading apparatus 1 includes a detector (not shown) suitable for monitoring the stacking threshold as the stacking is taking place and for acting after such detection to trigger the movements required for the next stage of the loading method described below.

The automatic stacking and loading apparatus 1 may also include automatic supply means (not shown) for automatically supplying said multi-compartment tray 200 to said tray-receiving surface 5 and/or automatic removal means (not shown) for automatically removing said multi-compartment tray 200 from the tray-receiving surface 5.

The method of the invention for automatically stacking flat articles 10 on edge and for automatically loading them on edge into a multi-compartment tray 200 as implemented by means of automatic stacking and loading apparatus 1 as described above, is explained below.

With reference to FIG. 1, the automatic stacking and loading apparatus 1 is empty in an initial position. The tray-receiving surface 5 is in its first position and capable of receiving a multi-compartment tray, the moving fingers 2 are in their low position, the stacking zone 4 is empty of flat articles to be stacked, the moving paddle 6 is in its start-of-stacking position and the presser flap 9 is in its retracted position.

With reference to FIG. 2, the method is started and a supply step is then performed during which a multi-compartment tray 200 is placed on the tray-receiving surface 5. Then, during a first engagement step, the moving fingers 2 are moved in translation so that they pass through the windows 206 of the first compartment 203 and then come flush with the top of the multi-compartment tray 200 and with the stacking zone 4, their movement in translation being stopped when they are in this high position so that the free ends of the moving fingers 2 define the bearing surface on which the flat articles 10 are to be stacked. The stacking zone 4 is still empty, the moving paddle 6 is in its start-of-stacking position, the presser flap 9 is in its retracted position, and the tray-receiving surface 5 is in its first position.

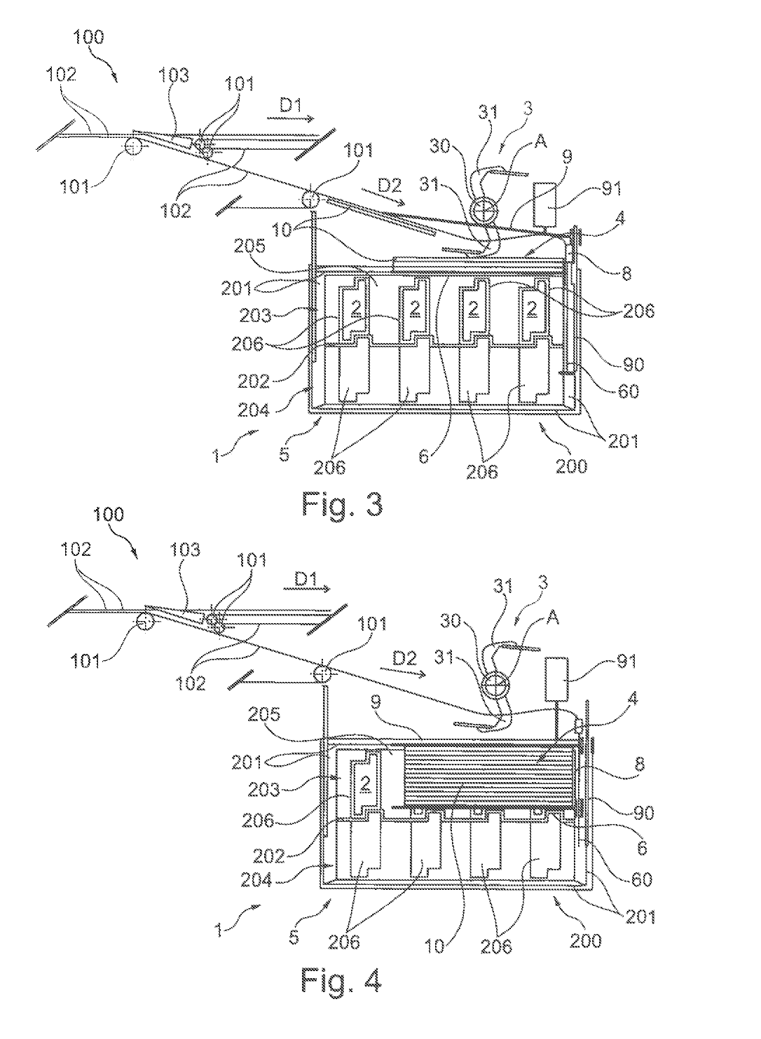

Then, with reference to FIG. 3, a first stacking step is performed during which, by means of the actuator 3, flat articles 10 are stacked on edge on the bearing surface and against the moving paddle 6. The stacking zone 4 is being filled above the first compartment 203 of the multi-compartment tray 200. The flat articles 10 are thus stacked as they arrive, the moving paddle 6 being gradually moved from its start-of-stacking position towards its end-of-stacking position. The presser flap 9 remains in its retracted position, and the tray-receiving surface 5 remains in its first position.

With reference to FIG. 4, once the detector has detected that the stacking threshold has been reached in the stacking zone 4, the stacking is interrupted, the stack of flat articles 10 stacked against the moving paddle 6 is tamped by moving and pivoting the presser flap 9 towards the moving paddle 6 that is temporarily blocked so as to limit friction, a first loading step is performed during which the moving fingers 2 are retracted gradually through the windows 206 so as to accompany the lowering of the flat articles 10 into the first compartment 203 until their edges are resting on the bottom plate 205.

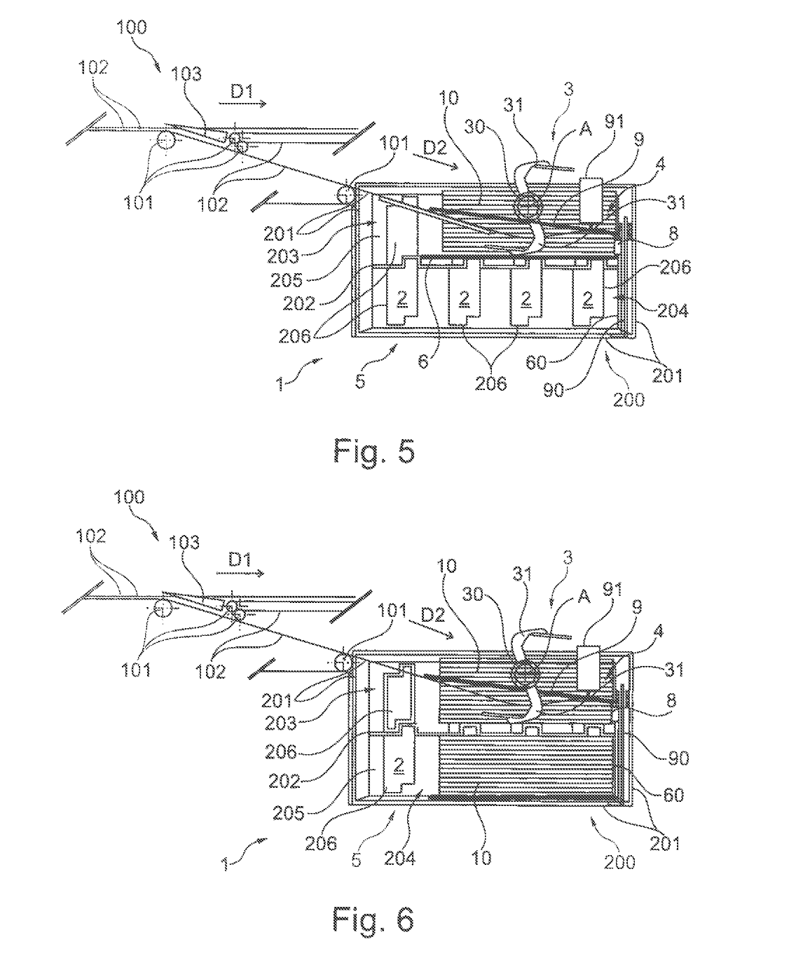

Then, with reference to FIG. 5, a shift step is performed during which the tray-receiving surface 5 is moved from its first position to its second position so that the moving fingers 2 are no longer in register with the windows 206 of the first compartment 203 but rather they are in register with the windows 206 of the second compartment 204. The presser flap 9 is returned to its retracted position and a second engagement step is performed during which the moving fingers 2 are moved in translation in a manner similar to the way they are moved in translation in the first engagement step, the moving fingers 2 then passing through the windows 206 of the second compartment 204 until they define a bearing surface above the second compartment 204. The moving paddle 6 remains in its start-of-stacking position.

With reference to FIG. 6, a second stacking step is then performed that is similar to the first stacking step, and then, when the detector has, once again, detected the stacking threshold, the stack is tamped by means of the presser flap 9, a second loading step is performed that is similar to the first loading step, and during which the moving fingers 2 are retracted gradually so as to accompany the lowering of the flat articles 10 into the second compartment 204 until their edges are resting on the bottom plate 205, and the presser flap 9 is moved towards its retracted position.

Then, a removal step is performed during which the multi-compartment tray 200 in which the first and second compartments 203, 204 have been loaded with the flat articles 10 on edge is removed from the tray-receiving surface 5.

The automatic stacking and loading method may be continued by loading another multi-compartment tray 200. To this end, a first option consists in putting the automatic stacking and loading apparatus 1 back into its initial position and in repeating the above-described steps. In a second option, it is also possible to use the automatic stacking and loading apparatus 1 with the tray-receiving surface 5 in its second position so as to start loading the second compartment 204 of the new multi-compartment tray 200 and then loading the first compartment 203 only afterwards.

The automatic stacking and unloading apparatus 1 and the automatic stacking and loading method of the invention thus make it possible to load multi-compartment trays 200 automatically with flat articles 10 stacked on edge.

1-10. (canceled)

11. An apparatus for automatically stacking flat articles on edge and for automatically loading them on edge into a multi-compartment tray having a bottom plate receiving the edges of said flat articles and provided with at least two through windows opening out into respective ones of first and second compartments of said multi-compartment tray, said automatic stacking and loading apparatus having at least one tray-receiving surface suitable for receiving at least one multi-compartment tray to be loaded, a stacking zone provided above said tray-receiving surface and suitable for receiving said flat articles while they are being stacked, and a stacker suitable for stacking said flat articles on edge in said stacking zone, said apparatus being characterized in that it has at least one moving finger designed to be in register with one of said windows in a multi-compartment tray placed on said tray-receiving surface, said moving finger being mounted to move relative to said tray-receiving surface and to said stacking zone between a low position in which its free end is set back from said tray-receiving surface and a high position in which its free end is flush with said stacking zone and defines a bearing surface for the flat articles that serves as a support for said flat articles while they are being stacked, in that said tray-receiving surface is mounted to move relative to said moving finger between a first position and a second position, in which positions said moving finger is designed to be successively in register with the window of said first compartment and then in register with the window of said second compartment.

12. The automatic stacking and loading apparatus according to claim 11, wherein at least one detector suitable for monitoring the stacking threshold for stacking of flat articles in said stacking zone and for controlling the movements of said moving finger and of said tray-receiving surface once a predetermined threshold value has been reached.

13. The automatic stacking and loading apparatus according to claim 11, wherein said apparatus has a row of moving fingers arranged to move simultaneously between said low and high positions.

14. The automatic stacking and loading apparatus according to claim 11, wherein said stacker is a rotary actuator of the bucket wheel type, and in that said automatic stacking and loading apparatus has at least one moving paddle provided facing said stacker and suitable for receiving in abutment the downstream face of the first flat article stacked in said stacking zone, and for moving away from said stacker as said flat articles are stacked behind said first flat article.

15. The automatic stacking and loading apparatus according to claim 11, further comprising an automatic supply means for automatically supplying said multi-compartment tray to said tray-receiving surface.

16. The automatic stacking and loading apparatus according to claim 11, further comprising an automatic removal means for automatically removing said multi-compartment tray from said tray-receiving surface.

17. A sorting machine for sorting flat articles, the machine including at least one unstacker, conveyor means, sorting outlets into which said flat articles are to be distributed in compliance with a predetermined sorting plan, and apparatus for stacking and loading flat articles on edge at said sorting outlets, said sorting machine being characterized in that it includes at least one automatic stacking and loading apparatus according to claim 11.

18. A method of automatically stacking flat articles on edge and of automatically loading them on edge into a multi-compartment tray having a bottom plate receiving the edges of said flat articles and provided with at least two through windows opening out into respective ones of first and second compartments of said multi-compartment tray, said method being characterized in that it comprises at least:
a supply step during which at least one multi-compartment tray is placed on a tray-receiving surface so that a moving finger is in register with the window in said first compartment;
a first engagement step during which at least one moving finger is engaged into said multi-compartment tray through the window in said first compartment so that, above said tray-receiving surface, said finger defines a bearing surface suitable for receiving said flat articles stacked on edge;
a first stacking step during which said flat articles are stacked on edge on said bearing surface;
a first loading step during which said moving finger is retracted from said first compartment so that the edges of said flat articles are resting on said bottom plate;
a shift step during which said multi-compartment tray is moved so that said moving finger is in register with the window in said second compartment;
a second engagement step during which the same moving finger as the one used during said first engagement step is engaged through said window in said second compartment so that, above said tray-receiving surface, the free end of said finger defines the same bearing surface as during said first engagement step;
a second stacking step similar to said first stacking step;
a second loading step during which said moving finger is retracted from said second compartment so that the edges of said flat articles are resting on said bottom plate; and
a removal step during which said multi-compartment tray is removed from said tray-receiving surface.

19. The automatic stacking and loading method according to claim 18, wherein prior to implementing said stacking and loading method, at least one predetermined threshold value is set as a function of the dimensions of said multi-compartment tray, in that, during at least one of said first and second stacking steps, the level of stacking of flat articles is compared with said stacking threshold, and in that, when said level of stacking reaches said predetermined threshold value, said first loading step, said second loading step, and said shift step are caused to take place in succession.

20. A postal sorting method during which at least one of the following steps is performed: unloading flat articles stacked on edge from a multi-compartment tray; unstacking said flat articles, sorting said flat articles, stacking said flat articles, and loading said flat articles into a multi-compartment tray, said postal sorting method being characterized in that said stacking and loading steps are performed as in said stacking and loading method of claim 18.
